(19) United States
(12) Patent Application Publication
(10) Pub. No.: US 2004/0162776 A1
(43) Pub. Date: Aug. 19, 2004

(54) High put/low call options

(76) Inventor: Jake Vrabel, Schererville, IN (US)

Correspondence Address: FOLEY & LARDNER, 321 NORTH CLARK STREET, SUITE 2800, CHICAGO, IL, 60610-4764, US

(21) Appl. No.: 10/366,432

(22) Filed: Feb. 13, 2003

(51) Int. Cl. G06F 17/60

(52) U.S. Cl. 705/37

(57) ABSTRACT

A financial product in accordance with the principles of the present invention provides an option having a strike price predetermined by a trading point of a specified time period. A financial product in accordance with the principles of the present invention provides for at least two possible variations. The first is the right and obligation to be short at the high for a specified time period, be it a day, week, month, etc. The second is the right and obligation to be long at the low (or any percent thereof) for a specified time period, be it a day, week or month.

The present invention relates generally to options contracts.

### BACKGROUND OF THE INVENTION

A variety of different types of contracts are currently traded on various commodity exchanges throughout the world. A cash contract is a sales agreement for either immediate or future delivery of the actual product. Derivatives are contracts, such as an option or futures contract, whose value depends on the performance of an underlying commodity where delivery generally does not occur.

A futures contract is a legally binding agreement, made on the trading floor of a futures exchange, to buy or sell a commodity or financial instrument sometime in the future. A commodity is an article of commerce or a product that can be used for commerce. In a narrow sense not intended for use herein, futures and options contracts for commodities are products traded exclusively on an authorized commodity exchange. Examples of the types of commodities commonly include agricultural products such as corn, soybeans and wheat; precious metals such as gold; fuels such as petroleum; foreign currencies such as the Euro; financial instruments such as U.S. Treasury securities and financial indexes such as the Standard & Poor's 500 stock index, to name a few. Futures contracts are standardized according to the quality, quantity, duration and delivery time and location for each commodity.

An option is a contract that conveys the right, but not the obligation, to buy or sell a particular commodity at a certain price for a limited time. Only the seller of the option is obligated to perform. A call option is an option that gives the buyer the right, but not the obligation to purchase the underlying futures contract at a certain price on or before the expiration date. The price at which the buyer has the right, but not the obligation to purchase the underlying futures contract is called the strike price. The cost incurred for an option is commonly referred to as the premium.

A put option is an option that gives the option buyer the right, but not the obligation to sell the underlying futures contract at the strike price on or before the expiration date. An option buyer (also referred to as the holder) is the purchaser of either a call or put option. An option seller (also referred to as the writer) is the person who sells an option in return for a premium and is obligated to perform when the holder exercises his right under the option contract.

Another way of looking at the “rights” of the buyer and the “obligations” of the seller of a futures option is with respect to their respective position in the underlying commodity. Option buyers receive the right, but not the obligation, to, assume a futures position. The right of the buyer is usually synonymous with the “right,” but not the obligation, to be long or short a particular futures contract; the obligation of the seller are usually the reverse.

A simply example of a call option would be a call option on December corn at $2.50 for a 10 cents premium. The buyer for a cost of 10 cents would have the right, but not the obligation, for a specified time period to own corn at $2.50. Put differently, the seller would have the obligation to allow the buyer to be long December corn at $2.50. For this, he would receive the 10-cent premium and would have the “obligation” to be short December corn at $2.50. Most always, the liability that the seller incurs in writing an option is hedged at the commodity exchanges with a portfolio of futures and options on futures resulting in added volume and liquidity to the commodity exchange or with an offsetting cash position.

Many derivatives result on options not necessarily traded on organized commodity exchanges. These derivatives are commonly referred to as “over-the-counter” options. One example would be an “averaging option.” Averaging options pay at expiration the difference between the strike price and the “average” price over a specified time period. The “average price” can be determined in any number of ways.

In addition, commodity exchanges over the last several years, have introduced added products for options on futures. For example, the Chicago Board of Trade, 141 West Jackson Boulevard, Chicago, Ill. 60604-2994 (“CBOT”) trades serial options giving the marketplace an option contract to expire each month rather than the traditional options expiring similar to the futures months. Additionally, the CBOT has allowed 5-cent strikes (in the case of corn) for the serial and next futures month of which an option would be traded.

Both serial and 5-cent strike prices are actively traded, indicating the marketplace's desire for products closer to expiration as well as close to the underlying future. Thus, it would be desirable to offer further market opportunities to hedge trading needs within a given time period. It further would be desirable to offer further market alternates to liquidation for participants with existing positions. It further would be desirable to offer further market alternates to add additional liquidity to the market.

### SUMMARY OF THE INVENTION

A financial product in accordance with the principles of the present invention provides further market opportunities to hedge trading needs within a given time period. A financial product in accordance with the principles of the present invention offers further market alternates to liquidation for participants with existing positions. A financial product in accordance with the principles of the present invention provides additional liquidity to the market.

A financial product in accordance with the principles of the present invention would have a strike price predetermined by a trading point of a given period. A financial product in accordance with the principles of the present invention provides for at least two possible variations. The first is the right and obligation to be short at the high (or any percent thereof) for a specified time period, be it a day, week, month. The second is the right and obligation to be long at the low (or any percent thereof) for a specified time period, be it a day, week or month.

### DETAILED DESCRIPTION OF THE PREFERRED EMBODIMENTS

Traditionally, an option has a strike price that is determined prior to trading. A financial product in accordance with the principles of the present invention would have a determined strike price, in that it would be at a predetermined trading point of a given period. One product in accordance with the principles of the present invention would be trading the rights and obligations to sell the high (or any percent thereof) of a specified time period, be it a day, week or month. In the case of an option to sell the high of a day, the strike price for the option would be the high of a given day and could exercise automatically with a short position at the high of that given day. The seller of the option to sell the high of a day would receive a premium and for this, would be long the futures at the end of the session at the high. For the purposes of explanation and not to narrow the scope of the present invention, in the following explanation of financial instruments in accordance with the principles of the present invention this type of option can be referred to as a high put option.

Another product in accordance with the principles of the present invention would be trading the rights and obligations to buy the low (or any percent thereof) of a specified time period, be it a day, week or month. In the case of an option to buy the low of the day, the strike price for the option would be the low of a given day and could exercise automatically with a long position at the low of that given day. The seller of the option to buy the low of the day would receive a premium and for this, would be short the futures at the end of the session at the low. For the purposes of explanation and not to narrow the scope of the present invention, in the following explanation of financial instruments in accordance with the principles of the present invention this type of option can be referred to as a low call option.

The high put or low call could be traded at a percentage of the respective high or low of the respective time period. In the case of an option to sell a percentage of the high of a day, the strike price for the option would be that percentage of the high of a given day and could exercise automatically with a short position at that percentage of the high of that given day. The seller of the option to sell at the percentage of the high of a day would receive a premium and for this, would be long the futures at the end of the session at that percentage of the high. In the case of an option to buy a percentage of the low of the day, the strike price for the option would be that percentage of the low of a given day and could exercise automatically with a long position at that percentage of the low of that given day. The seller of the option to buy at the percentage of the low of the day would receive a premium and for this, would be short the futures at the end of the session at that percentage of the low. The percentage could be determined by the commodity exchange prior to the options being traded.

Such high put/low call option products in accordance with the principles of the present invention could be for any option traded be it on an organized commodity exchange or over the counter as well.

With the premium, the seller of a high put/low call option would be able to manage a portfolio of futures and options on futures to offset the liability he would have at the end of any session. These options could be automatically be exercised. As is the case with the options of the prior art, the closer to the high put/low call option expiring, the more defined the risk. At expiration, or the end of the trading session, the buyer of the high put option would have a net short futures position at the high of the given day minus the premium paid. In the case of low call option, the buyer would have a net long futures position plus the premium paid at the low of a given day.

The use of such options would appeal to many. In the commercial sector, buyers of cash commodities need to hedge their cash purchases with the selling of futures. Rather than sell the futures outright, one many elect to purchase an option that would provide a short position at the high of the day. The cost would be the premium paid. For example, an elevator operator could purchase grain from a farmer that needs to sell part of his crop within a given time frame in order to meet cash flow needs. Rather than guess at what price would be best, for a premium the farmer could sell the cash grain at the high for the next time period, be it a day, a week, a month, etc. The premium could be built into the cash contract. Conversely, a user of a given commodity could use a low call option to secure the low of a given period and allow the user the low of that period. Thus, a large sector of commodities trading could find value in a financial instrument in accordance with the principles of the present invention.

From the speculative side, managed funds along with the private speculator will be willing to buy the “right” to be short on the high of the day and would be able to trade the futures market during the day to offset any gains during the trading session by being short on the high of the day. A manager of a managed fund or a private speculator could liquidate any or all of a portion of a position by purchasing the option to sell the high of the day. In all cases, the offsetting liability created by the seller of an option could use the futures and options on futures market to hedge the liability created, thereby adding additional liquidity to the market.

Further, large commercial concerns will be willing to incur a long position at the high of the day for a given price. For example, a commercial user of corn may wish to price a cash contract with the seller of the cash grains on the close of a given trading session. The commercial corn user could sell an option (or write the option) to be short at the high (making him long at the high of the day), collect the premium, and profit if the market closed higher than the high of the day minus the premium collected.

It is likely that to offer someone the right to be short at the high of the day may prove to be costly. However, the cost will be reduced significantly if the buyer of an option would be short at a certain percentage of the daily range. As in the case of tradditional traded options, the further away from the strike price the option is the less the option will cost. In the case of a high put option for example, if the exercise price was at a percentage of the high for that time frame, the option would command less of a premium. Thus, financial instruments in accordance with the present invention can be designed to accommodate different pricing and different risks as the market dictates.

The following are non-limiting illustrative examples of financial products in accordance with the principles of the present invention wherein certain teachings in each example can be combined and mixed in other embodiments thereby more fully illustrating the scope of the inventions.

The following are non-limiting illustrative examples of the principles of the present invention.

### EXAMPLE 1

For example, if November soybeans had a 10-cent range for a given day, the buyer of a high-put option would be short at a given percent of the daily range added to the low. Assume that November soybeans have a range of 10 cents with the high being $5.50 and the low being $5.40. The owner of the option would be short at 10 cents times the given percent added to the low. If the percent were 90%, the owner would have the right to be short at $5.49. The seller of the option would be long at $5.49. In this example, these options would not be automatically exercised. If the market closed at $5.50, the buyer would likely chose to not exercise the option to be short at $5.49 since the market closed above the exercise price.

### EXAMPLE 2

Assume the market for an expiration month at a specific futures contract (“SF”) opens with a range of $5.55 to $5.56. Assume the current trade is at $5.55 and within the first five minutes of trading, the high is $5.56 and the low is $5.54. Assume that the right for a high put is at 4 cents and the right for a low call is 4 cents as well. A trader could sell either of these and collect 4 cents. If he sells the high put, he will be willing to give someone the right to be short at the high of the day (“HOD”), and thus, assume a long position at the end of the trading session on the HOD. From this point onward, the trader's risk is if the market breaks from the high of the day sometime during the session and he is not covered for the downward move.

The trader who sold the option can offset the liability he has created for the session with a portfolio of futures and options on futures, which may very well include serial options for the underlining futures contract. At 9:40 a.m., assume the market has been trading between $5.56 and $5.55. At 9:50 a.m., assume the market makes a new high for the session at $5.59. The current bid offer for the high put is 3 to 4 cents. The market maker could try to buy the high put at 3 cents or continue to hold the liability.

Assume trade continues throughout the morning between the prices of $5.59 and $5.55 and at noon, the market is at $5.56½. At this point, with one hour and fifteen minutes left to trade, the high for the day is $5.59 and the low is $5.54. The intrinsic value for the high put option is currently 2½ cents or the difference between the high and the current price. The time value of the high put option for the last one hour and fifteen minutes of trade remaining is 1½ cents leaving the value of the high put still at 4 cents.

As the session comes to an end, assume SF rallies into the close and makes a new high for the session at $5.63¾ and settles for the day at $5.63½. If the buyer of the high put option elects to exercise his right to be short on the high of the day—in this example, at $5.63¾—his net short price is $5.59¾, which is the high of the day minus the premium he paid for the right to be short. In the case of the option being exercised, the local trader is now short SF at $5.63½ plus the premium he collected and any trading activity during the session to adjust for the liability he created for himself.

### EXAMPLE 3

The other side of the scenario is the low call option. At the opening of SF, the low call option was priced at 4 cents. As in the case of Example 2 above, at noon with SF at $5.56½, the intrinsic value of the low call would be 2½ cents. As the market moves into the close and SF rallies, the intrinsic value increases tick for tick with the futures. When SF trades to a new high of $5.62, the intrinsic value is now 8 cents. Thus, the low call option is behaving like a futures contract and will continue to do so for the rest of the session since it appears that SF will not end the day near the low.

When SF settles the trading session at $5.63½, the buyer of the low call exercises his right to be long at the low of the session and is long at $5.54 plus the premium paid of 4 cents for a net long price of $5.58. The buyer of the low call option has a maximum risk of 4 cents or the premium paid. In this case, the option would certainly be exercised and the market maker who sold the option would in fact be short SF at $5.54.

### EXAMPLE 4

During same session as Example 3, the market maker could elect to sell both the low call and the high put options and collect the entire 8 cents premium. If he does so, his risk is that the trading range for the day is greater than 8 cents. If the range in only six cents, he sells the low and buys the high for a net loss of 6 cents. He collected 8 cents in premium for a net profit of 2 cents on the day.

In the above Examples 3 and 4, because the market is making new highs late in the session, an individual who is long futures in the SF contract and has no position in the low call or high put options, could very well sell a low call option and collect the premium. Now the long in futures market sells the right to buy the low of the day and collects the premium. This in effect could be greater than what could be realized by selling the long futures position outright because the low call option would be the total of the intrinsic value as well as any time premium left in the option.

Thus far, the only discussion has been for the high put or low call options for a given trading session. There is the possibility that the market may desire a high put and low call options for a given week, month or other time interval. This of course would be more costly; however, the appeal to the commercial sector may be considerably greater. This likely would hold true mostly for the traders of longer-term commodities such as agricultural products like for example corn, soybeans, and wheat.

Trading of financial products in accordance with the principles of the present invention would appeal to both the speculative as well as the commercial trade both in the buying and selling of the options. Financial products in accordance with the principles of the present invention offer market opportunities to individuals with the use of high put and low call options, opportunities for commercial concerns to hedge trading needs within a given time period and finally, an alternate to liquidation for participants with existing positions.

While the invention has been described with specific examples, other embodiments, alternatives, modifications and variations will be apparent to those skilled in the art. Accordingly, it is intended to include all such embodiments, alternatives, modifications and variations set forth within the spirit and scope of the appended claims.

What is claimed is:

1. A method of creating an option comprising:
trading a right and obligation to sell the high of a specified time period.

2. The method of creating an option of claim 1 further including establishing a strike price for the option at the high of the specified time period.

3. The method of creating an option of claim 2 further including exercising the strike price automatically with a short position at the high of the specified time period.

4. The method of creating an option of claim 1 further including establishing a strike price for the option at a predetermined percentage of the high of a given day.

5. The method of creating an option of claim 1 further including a seller of the option holding a long position in the futures at the end of the session at the high.

6. The method of creating an option of claim 1 further including specifying the time period as a day.

7. The method of creating an option of claim 1 further including specifying the time period as a week.

8. The method of creating an option of claim 1 further including specifying the time period as a month.

9. The method of creating an option of claim 1 further including applying the option to any option traded be it on an organized commodity exchange or over the counter.

10. A financial product comprising:
a right and obligation to be short at the high for a specified time period.

11. The financial product of claim 10 further including a strike price for the option to sell the high of the specified time period.

12. The financial product of claim 11 further wherein the strike price is exercised automatically with a short position at the high of the specified time period.

13. The financial product of claim 10 further including a strike price for the option to sell at a predetermined percentage of the high of a given day.

14. The financial product of claim 10 wherein the seller of an option to sell the high of a day is long the futures at the end of the session at the high.

15. The financial product of claim 10 wherein the specified time period is a day.

16. The financial product of claim 10 wherein the specified time period is a week.

17. The financial product of claim 10 wherein the specified time period is a month.

18. The financial product of claim 10 wherein the financial product applies to any option traded be it on an organized commodity exchange or over the counter.

19. A method of creating an option comprising:
trading a right and obligation to buy the low of a specified time period.

20. The method of creating an option of claim 19 further including establishing a strike price for the option at the low of the specified time period.

21. The method of creating an option of claim 20 further including exercising the strike price automatically with a long position at the low of the specified time period.

22. The method of creating an option of claim 19 further including establishing a strike price for the option at a predetermined percentage of the low of the specified time period.

23. The method of creating an option of claim 19 further including the seller of the option holding a short position the futures at the end of the session at the low.

24. The method of creating an option of claim 19 further including specifying the time period as a day.

25. The method of creating an option of claim 19 further including specifying the time period as a week.

26. The method of creating an option of claim 19 further including specifying the time period as a month.

27. The method of creating an option of claim 19 further including applying the option to any option traded be it on an organized commodity exchange or over the counter.

28. A financial product comprising:
a right and obligation to be long at the low for a specified time period.

29. The financial product of claim 28 further including a strike price for the option to buy the low of the specified time period.

30. The financial product of claim 29 wherein the strike price is exercised automatically with a long position at the low of the specified time period.

31. The financial product of claim 28 further including a strike price for the option to buy a predetermined percentage of the low of the specified time period.

32. The financial product of claim 28 wherein the seller of the option to buy the low of the specified time period is short the futures at the end of the session at the low of the specified time period.

33. The financial product of claim 28 wherein the specified time period is a day.

34. The financial product of claim 28 wherein the specified time period is a week.

35. The financial product of claim 28 wherein the specified time period is a month.

36. The financial product of claim 28 wherein the financial product applies to any option traded be it on an organized commodity exchange or over the counter.

37. A financial product comprising:
an option having a strike price predetermined by a trading point of a specified time period.

38. The financial product of claim 37 further wherein the strike price for the option is the high of the specified time period.

39. The financial product of claim 37 further wherein the strike price for the option is the low of the specified time period.

40. The financial product of claim 37 further wherein the strike price for the option is a predetermined percentage of the high of the specified time period.

41. The financial product of claim 37 further wherein the strike price for the option is a predetermined percentage of the low of the specified time period.

42. The financial product of claim 37 wherein the specified time period is a day.

43. The financial product of claim 37 wherein the specified time period is a week.

44. The financial product of claim 37 wherein the specified time period is a month.

45. The financial product of claim 37 wherein the financial product applies to any option traded be it on an organized commodity exchange or over the counter.
